(19) United States
(12) Patent Application Publication
(10) Pub. No.: US 2010/0007991 A1
(43) Pub. Date: Jan. 14, 2010

(54) CARRIAGE ASSEMBLY AND RECORDING MEDIUM DRIVE

(75) Inventor: Toru Kohei, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/560,174

(22) Filed: Sep. 15, 2009

Related U.S. Application Data
(63) Continuation of application No. PCT/JP2007/059258, filed on Apr. 27, 2007.

(51) Int. Cl. G11B 5/60

(52) U.S. Cl. 360/234.3; G9B/5.229

(57) ABSTRACT

According to one embodiment, a carriage assembly includes a carriage block main body, a carriage arm, a head suspension, a flexible printed circuit board, and a viscoelastic adhesive. The carriage block main body is rotatably supported by a shaft. The carriage arm extends from the carriage block main body. The head suspension is attached to an end of the carriage arm, and supports a head slider at an end. The flexible printed circuit board is partially fixed to the head suspension, extends from the head suspension toward the carriage block main body, and is affixed to a surface of the carriage arm. The viscoelastic adhesive is sandwiched between the carriage arm and the flexible printed circuit board.

### CROSS-REFERENCE TO RELATED APPLICATIONS

This application is a continuation of PCT international application Ser. No. PCT/JP2007/059258 filed on Apr. 27, 2007 which designates the United States, incorporated herein by reference.

### BACKGROUND

1. Field

One embodiment of the invention relates to a carriage assembly that is incorporated in a recording medium drive.

2. Description of the Related Art

As disclosed in, for example, Japanese Patent Application Publication (KOKAI) No. H9-255449 and Japanese Patent Application Publication (KOKAI) No. H9-7145, a groove is formed on a side surface of a carriage arm. In the groove, a flexible printed circuit board is received. The flexible printed circuit board connects a flying head slider and a flexible printed circuit board on a carriage block. The flexible printed circuit board is affixed to the carriage arm in the groove with adhesive, for example.

Rotation of a magnetic disk produces an air flow along a surface of the magnetic disk. Such an air flow flutters a portion of a flexible printed circuit board that sticks out from the carriage arm, for example. Flutter causes resonance of the carriage arm. As a result, the positioning accuracy of the flying head slider is degraded.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a hard disk drive (HDD) as an example of a recording medium drive according to an embodiment of the invention;

FIG. 2 is an exemplary partial perspective view of a configuration of a carriage assembly in the embodiment;

FIG. 3 is an exemplary cross-section of the carriage arm in the embodiment;

FIG. 4 is an exemplary graph of frequency resonance of vibration; and

FIG. 5 is an exemplary graph of frequency resonance of vibration.

### DETAILED DESCRIPTION

Various embodiments according to the invention will be described hereinafter with reference to the accompanying drawings. In general, according to one embodiment of the invention, a carriage assembly comprises a carriage block main body, a carriage arm, a head suspension, a flexible printed circuit board, and a viscoelastic adhesive. The carriage block main body is configured to be rotatably supported by a shaft. The carriage arm is configured to extend from the carriage block main body. The head suspension is configured to be attached to an end of the carriage arm, and support a head slider at an end. The flexible printed circuit board is configured to be partially fixed to the head suspension, extend from the head suspension toward the carriage block main body, and be affixed to a surface of the carriage arm. The viscoelastic adhesive is sandwiched between the carriage arm and the flexible printed circuit board.

According to another embodiment of the invention, a recording medium drive comprises a housing, a shaft, a carriage block main body, a carriage arm, a head suspension, a flexible printed circuit board, and a viscoelastic adhesive. The shaft is configured to be incorporated in the housing. The carriage block main body is configured to be rotatably supported by the shaft. The carriage arm is configured to extend from the carriage block main body. The head suspension is configured to be attached to an end of the carriage arm, and support a head slider at an end. The flexible printed circuit board is configured to be partially fixed to the head suspension, extend from the head suspension toward the carriage block main body, and be affixed to a surface of the carriage arm. The viscoelastic adhesive is sandwiched between the carriage arm and the flexible printed circuit board.

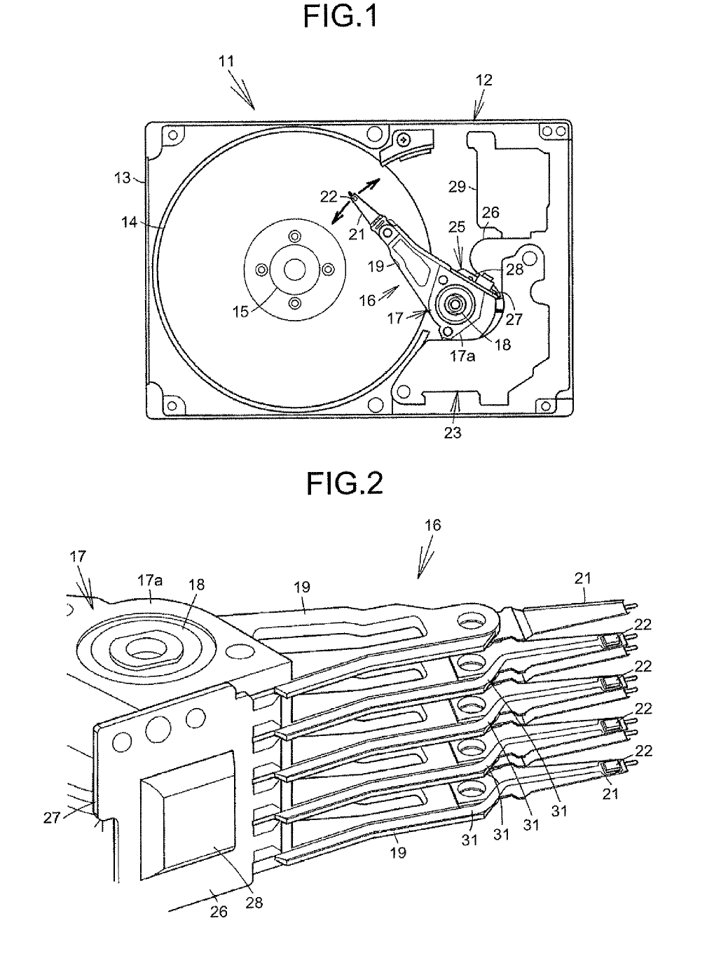

FIG. 1 schematically illustrates an internal structure of a hard disk drive (HDD) 11 as an example of a recording medium drive according to an embodiment of the invention. The HDD 11 comprises a housing 12. The housing 12 is constituted of a box-shaped base 13 and a cover (not illustrated). The base 13 sections, for example, a flat rectangular parallelepiped internal space, i.e., a housing space. The base 13 may be formed by casting with a metallic material such as aluminum. The cover is connected to an opening of the base 13. The housing space is sealed between the cover and the base 13. The cover may be formed by, for example, pressing a piece of plate.

In the housing space, at least one piece of magnetic disk 14 as a recording medium is housed. The magnetic disk 14 is mounted on a spindle motor 15. The spindle motor 15 can rotate the magnetic disk 14 at high speed, such as 5400 rpm, 7200 rpm, 10000 rpm, and 15000 rpm.

In the housing space, a carriage assembly 16 is further housed. The carriage assembly 16 comprises a carriage block 17. The carriage block 17 comprises a carriage block main body 17a that is rotatably connected to a shaft 18 stretching in a vertical direction. With the carriage block main body 17a, a plurality of carriage arms 19 that stretch from the shaft 18 in a horizontal direction are integrated. The carriage block 17 may be formed by, for example, extruding aluminum.

Attached to an end of each of the carriage arms 19 is a head suspension 21. The head suspension 21 may be attached by swaging. At swaging, a hole formed at the end of the carriage arm 19 and a hole formed at a rear end of the head suspension 21 may be positioned to each other. The head suspension 21 stretches forward from the end of the carriage arm 19. At a front end of the head suspension 21, a flying head slider 22 is supported. On the flying head slider 22, a head device, i.e., an electromagnetic transducer device, is mounted.

When an air flow is produced on a surface of the magnetic disk 14 by rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating at relatively high stiffness during the rotation of the magnetic disk 14.

When the carriage assembly 16 rotates about the shaft 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. Thus, the electromagnetic device on the flying head slider 22 is positioned on the targeted recording track.

To the carriage block 17, a power source such as a voice coil motor (VCM) 23 is connected. By the action of this VCM 23, the carriage block main body 17a can rotate about the shaft 18. Such rotation of the carriage block main body 17a enables reciprocation of the carriage arm 19 and the head suspension 21.

As can be seen from FIG. 1, a flexible printed-circuit-board module 25 is arranged on the carriage block main body 17a. The flexible printed-circuit-board module 25 comprises a flexible printed circuit board 26. The flexible printed circuit board 26 can be affixed to a surface of a metal plate 27, for example, of stainless steel. The metal plate 27 may be fixed to the carriage block main body 17a with, for example, a screw.

On the flexible printed circuit board 26, a head integrate circuit (IC) 28 is mounted. At the time of reading magnetic information, a sense current is supplied from this head IC 28 to a read head device of the electromagnetic transducer device. Similarly, at the time of writing magnetic information, a write current is supplied from the head IC 28 to a write head device of the electromagnetic transducer device. To the head IC 28, a sense current or a write current is supplied from a compact circuit board 29 that is arranged in the housing space, or a printed wiring board (not illustrated) that is attached on a rear side of a bottom plate of the base 13.

As illustrated in FIG. 2, a flexible printed circuit board 31 is used to supply a sense current or a write current. The flexible printed circuit boards 31 are partially affixed to the respective head suspensions 21 at one end. The flexible printed circuit board 31 stretches from the head suspension 21 to a read side along a side edge of the carriage arm 19. The flexible printed circuit board 31 is partially affixed to the carriage arm 19. A rear end of the flexible printed circuit board 31 is overlapped on the flexible printed circuit board 26. The flexible printed circuit board 31 is formed in a so-called long tail shape.

At the other end of the flexible printed circuit board 31, the flying head slider 22 is supported. That is, the flexible printed circuit board 31 constitutes a flexure. The action of the flexure enables a change of posture of the flying head slider 22. As described later, the flexible printed circuit board 31 comprises a wiring pattern (not illustrated). On end of the wiring pattern is connected to the flying head slider 22. The other end of the wiring pattern is connected to the flexible printed circuit board 26. Thus, the flying head slider 22 is electrically connected to the flexible printed circuit board 26, i.e., the head IC 28.

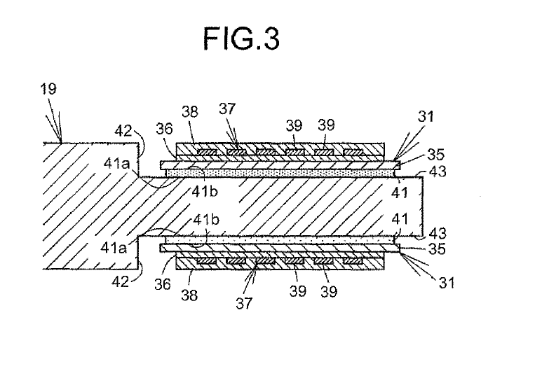

As illustrated in FIG. 3, the flexible printed circuit board 31 comprises a metal plate 35. The metal plate 35 may be made of, for example, stainless steel. The flexible printed circuit board 31 comprises an insulating layer 36, a conductive layer 37, and a protective layer 38 that are layered on the metal plate 35 in order. The conductive layer 37 comprises six wiring patterns 39. Four out of the six wiring patterns 39 are used to supply a sense current or a write current. The remaining two wiring patterns 39 are used to supply a current to a heater that is incorporated in the flying head slider 22, for example. The heater is used for a so-called dynamic flight height (DFH). For the conductive layer 37, a conductive material such as copper is used. For the insulating layer 36 and the protective layer 38, a resin material such as polyimide is used.

The flexible printed circuit board 31 is affixed to the carriage arm 19 with viscoelastic adhesive 41. 70% of the total area of the flexible printed circuit board 31 should be affixed. As long as this area is affixed, the flexible printed circuit board 31 may be affixed to the carriage arm 19 at, at least, one region. As the viscoelastic adhesive 41, for example, a double-face tape of viscoelastic material (VEM) may be used. The viscoelastic adhesive 41 has a first side 41a adjacent to the carriage arm 19 and a second side 41b adjacent to the flexible printed circuit board 31, i.e., the metal plate 35. The bond strength of the first side 41a differs from the bond strength of the second side 41b. In this example, it suffices that the bond strength of the second side 41b is set larger than the bond strength of the first side 41a.

As can be seen from FIG. 3, a step 42 is formed in the carriage arm 19. A step surface 43 that is one level lower than the step 42 is formed relative to the step 42. The flexible printed circuit board 31 is affixed on the step surface 43. The height of the flexible printed circuit board 31 from the step surface 43 should correspond to the height of the step 42. Thus, the surface of the carriage arm 19 and the surface of the flexible printed circuit board 31 are arranged substantially on an identical plane. Accordingly, air smoothly flows along the surface of the carriage arm 19 and the surface of the flexible printed circuit board 31. Flutter of the flexible printed circuit board 31 is prevented.

In the HDD 11 as described above, the flexible printed circuit board 31 is affixed to the carriage arm 19 with the viscoelastic adhesive 41. When the magnetic disk 14 rotates, an air flow is produced along the surface of the magnetic disk 14. A portion of the flexible printed circuit board 31 positioned outside the rim the carriage arm 19 or the flying head slider 22 flutters. The viscoelastic adhesive 41 works to attenuate vibration of the flexible printed circuit board 31. The resonance of the carriage arm 19 is suppressed. As a result, the positioning accuracy of the flying head slider 22 is improved.

Besides, the bonding strength of the viscoelastic adhesive 41 is larger on the second side 41b adjacent to the flexible printed circuit board 31. Therefore, for example, when the flexible printed circuit board 31 is pulled off from the carriage arm 19 to replace the flexible printed circuit board 31, the viscoelastic adhesive 41 comes with the flexible printed circuit board 31 while adhering thereto. This avoids the viscoelastic adhesive 41 residual on the carriage arm 19. The replacement work can be efficiently done.

The inventors verified the effect of the embodiment. For the verification, the inventors prepared the HDD 11 according to the specific example of the embodiment and an HDD as a comparative example. In the specific example, the flexible printed circuit board 31 was affixed to the step surface 43 of the carriage arm 19 with the viscoelastic adhesive 41. In the comparative example, the flexible printed circuit board was arranged in a groove formed on a side of a carriage arm. Magnetic information was read from a magnetic disk by an electromagnetic transducer device of a flying head slider. The frequency resonance of vibration was analyzed based on the read magnetic information.

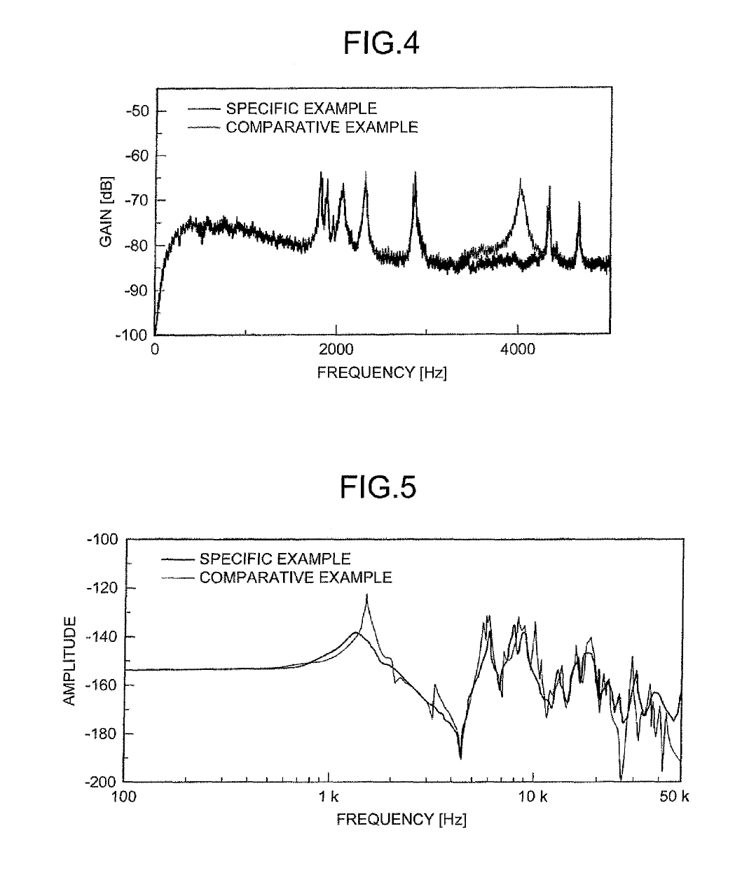

As a result, as illustrated in FIG. 4, frequency gain decreased in the specific example compared to that of the comparative example. The gain decreased particularly in a range of 3500 Hz to 4500 Hz of frequency. Such frequency is understood as vibration of one end and the other end of the flexible printed circuit board 31. In other words, it was confirmed that vibration of the flexible printed circuit board 31 was suppressed by the action of the viscoelastic adhesive 41 in the HDD 11 of the specific example.

Next, the inventors verified the damping effect on the actuator structure by the affixation of the flexible printed circuit board 31 with the viscoelastic adhesive 41. For the verification, the inventors prepared the HDD 11 according to the specific example of the embodiment and an HDD as a comparative example. In the specific example, the flexible printed circuit board 31 was affixed to the step surface 43 of the carriage arm 19 with the viscoelastic adhesive 41. In the comparative example, the flexible printed circuit board was affixed to a carriage arm with a high rigidity adhesive. By applying vibration to the whole actuator, displacement response was measured at the end of the actuator and was defined by a frequency axis.

As a result, as illustrated in FIG. 5, comparing the size of frequency amplitude in the recording-plane direction of the disk for the carriage arm 19 established in the vertical direction perpendicular to the base 13, the peak decreased as a whole in the specific example compared to that of the comparative example. In the HDD 11 of the specific example, the peak of primary resonance of the carriage arm 19 decreased compared to that of the comparative example. In other words, it was confirmed that, by the property of the viscoelastic adhesive 41, not only vibration of the flexible printed circuit board 31, but also vibration of each part of the actuator was suppressed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A carriage assembly comprising:
a carriage block main body configured to be rotatably supported by a shaft;
a carriage arm configured to extend from the carriage block main body;
a head suspension configured to be attached to an end of the carriage arm, and support a head slider at an end;
a flexible printed circuit board configured to be partially fixed to the head suspension, extend from the head suspension toward the carriage block main body, and be affixed to a surface of the carriage arm; and
a viscoelastic adhesive between the carriage arm and the flexible printed circuit board.

2. The carriage assembly according to claim 1, wherein the flexible printed circuit board is configured to be received on a step surface that is formed on the carriage arm and is one level lower than a surface of the carriage arm.

3. The carriage assembly according to claim 1, wherein the viscoelastic adhesive has different bonding strengths on a first side and on a second side, the first side being adjacent to the carriage arm, the second side being adjacent to the flexible printed circuit board.

4. The carriage assembly according to claim 3, wherein the second side is configured to have a bonding strength larger than a bonding strength of the first side.

5. A recording medium drive comprising:
a housing;
a shaft configured to be incorporated in the housing;
a carriage block main body configured to be rotatably supported by the shaft;
a carriage arm configured to extend from the carriage block main body;
a head suspension configured to be attached to an end of the carriage arm, and support a head slider at an end;
a flexible printed circuit board configured to be partially fixed to the head suspension, extend from the head suspension toward the carriage block main body, and be affixed to a surface of the carriage arm; and
a viscoelastic adhesive between the carriage arm and the flexible printed circuit board.

6. The recording medium drive according to claim 5, wherein the flexible printed circuit board is configured to be received on a step surface that is formed on the carriage arm and is one level lower than a surface of the carriage arm.

7. The recording medium drive according to claim 5, wherein the viscoelastic adhesive has different bonding strengths on a first side and on a second side, the first side being adjacent to the carriage arm, the second side being adjacent to the flexible printed circuit board.

8. The recording medium drive according to claim 7 wherein the second side is configured to have a bonding strength larger than a bonding strength of the first side.
